(19) United States
(12) Patent Application Publication
(10) Pub. No.: US 2020/0227849 A1
(43) Pub. Date: Jul. 16, 2020

(54) Structure of Connection of Cable and Circuit Board

(71) Applicant: TC & C Electronic Co., Ltd., Taoyuan (TW)

(72) Inventor: Li Hua Chung, Taoyuan (TW)

(21) Appl. No.: 16/385,890

(22) Filed: Apr. 16, 2019

(30) Foreign Application Priority Data
Jan. 14, 2019 (TW) 108101412

(51) Int. Cl. H01R 12/75; H01R 12/72

(52) U.S. Cl. CPC H01R 12/75; H01R 12/721

(57) ABSTRACT

A structure of a connection of a circuit board and a cable includes a circuit board, a cable, and a covering member. The circuit board has a plurality of bonding pads and openings. The cable has a plurality of conducting terminals, and the conducting terminals of the cable are connected to the bonding pads of the circuit board. The covering member is connected to the circuit board to cover the bonding pads of the circuit board and the conducting terminals of the cable. The covering member having a plurality of posts received in the openings of the circuit board. The structure may provide the cable and the circuit board with a firm connection.

### BACKGROUND OF THE INVENTION

### 1. Technical Field

The invention relates to an electrical connector, and more particularly to a structure of a connection of a cable to a circuit board.

### 2. Description of Related Art

In the art of computer, a mainboard and a peripheral device, such as hard disk drive and video card, are electrically connected through a predetermined connector for data transmission. Typically, conventional connectors include several types, such as a cable having one end connected to a printed circuit board (PCB), a cable having one end connected to a PCB with a socket, and a cable having opposite ends connected to a PCB and a PCB with a socket.

For such connector, the PCB and the cable are the basic elements. The cable is connected to the PCB by welding. In order to prevent the cable from disconnecting to the PCB, the PCB is provided with a covering layer to protect the welding portion, and the covering layer usually is made by molding.

However, the conventional PCB does not provide any structure for providing the covering layer, so that any external force exerted on the connector might damage the covering layer and case disconnection of the cable.

### BRIEF SUMMARY OF THE INVENTION

In view of the above, the primary objective of the present invention is to provide a structure for connecting a cable to a PCB, which may overcome the drawback of the conventional structure as described in the background, and provide the cable and the PCB with a strong strength of connection so as to reduce a risk of the cable disconnected to the PCB when an external force is exerted onto the cable.

In order to achieve the objective of the present invention, a structure of a connection of a circuit board and a cable includes a circuit board, a cable, and a covering member. The circuit board has a plurality of bonding pads and at least an opening. The cable has a plurality of conducting terminals, and the conducting terminals of the cable are connected to the bonding pads of the circuit board. The covering member is connected to the circuit board to cover the bonding pads of the circuit board and the conducting terminals of the cable. The covering member having at least a post received in the opening of the circuit board.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is an exploded view of a first preferred embodiment of the present invention;

FIG. 2 is a perspective view of the first preferred embodiment of the present invention;

FIG. 3 is a top view of the first preferred embodiment of the present invention;

FIG. 4 is a sectional view of the first preferred embodiment of the present invention, showing the twin-core cable with ground line;

FIG. 5 is a sectional view of the first preferred embodiment of the present invention, showing the twin-core cable without ground line;

FIG. 6 is a top view of the first preferred embodiment of the present invention, showing the extending portion of the PCB with the metal grounding layer;

FIG. 7 is a partial top view of the first preferred embodiment of the present invention, showing the welding portion of the PCB and the cable;

FIG. 8 is an exploded view of a second preferred embodiment of the present invention;

FIG. 9 is a perspective view of the second preferred embodiment of the present invention; and

FIG. 10 is a sectional view of the second preferred embodiment of the present invention.

### DETAILED DESCRIPTION OF THE INVENTION

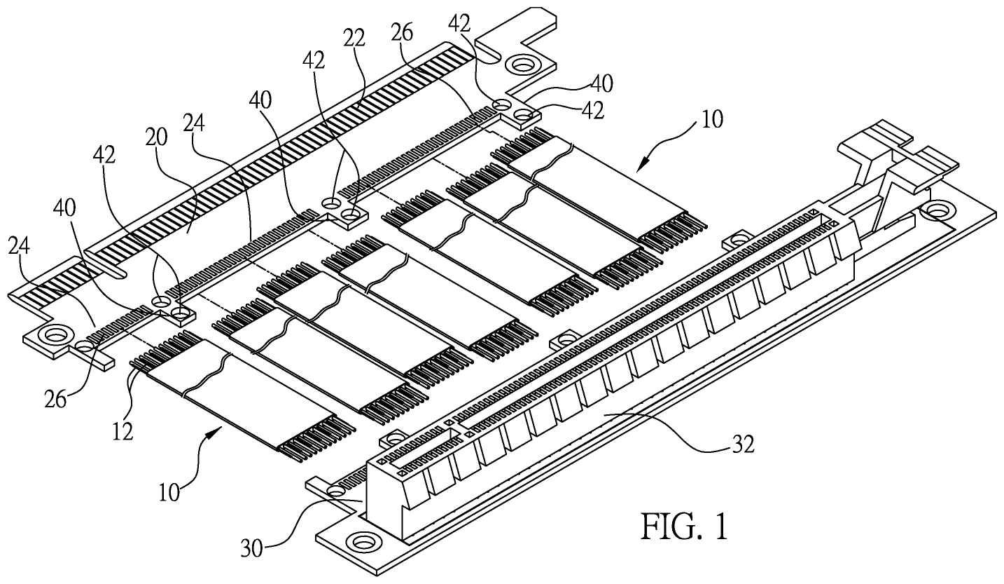

FIG. 1 shows a structure of the first preferred embodiment of the present invention includes a cable 10 having opposite ends connected to circuit boards 20 and 30 respectively. The circuit board 20 has a plurality of edge-board contacts 22 at an end opposite to an end connected to the cable 10. The circuit board 30 is provided with a socket 32, and is connected to the cable 10 by welding.

The circuit board 20 is provided with a plurality of extending portions 40 projected from the end connected to the cable 10, and each of the extending portions 40 has two openings 42. The circuit board 20 has welding portions 24 between each two of the neighboring extending portions 40, and each of the welding portions 24 has a plurality of bonding pads 26. The cable 10 has a plurality of conducting terminals 12, and ends of the conducting terminals 12 are fixedly connected to the bonding pads 26 of the circuit board 20 by welding.

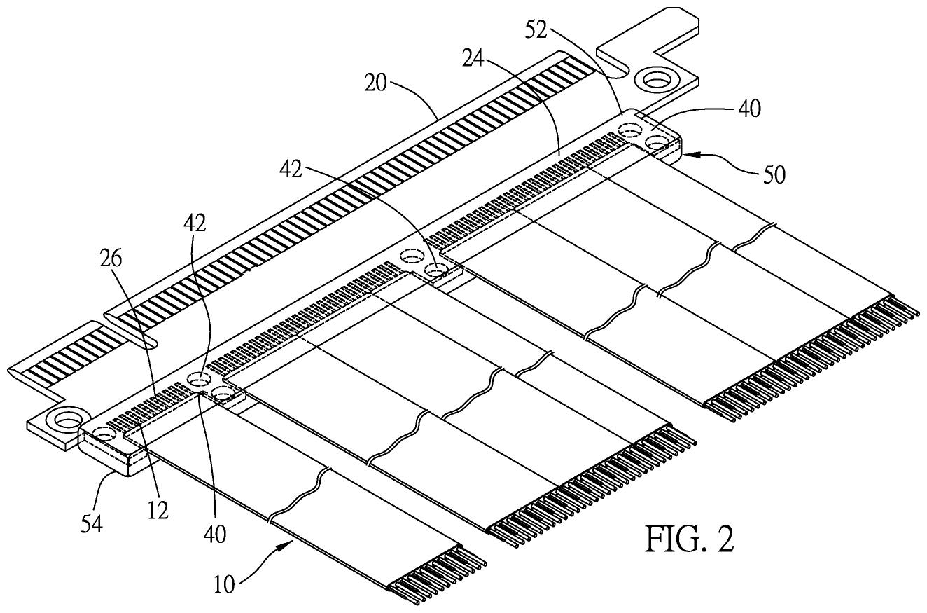

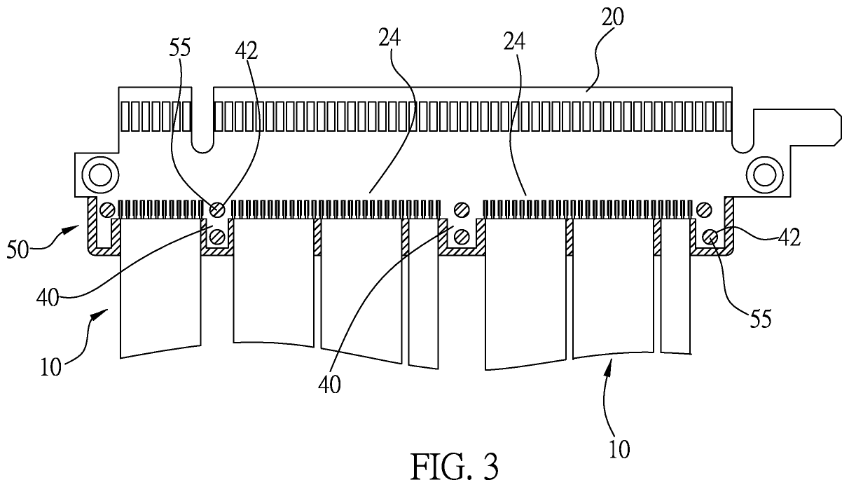

As shown in FIG. 2 and FIG. 3, a covering member 50 is connected to the circuit board 20. The covering member 50 has a first sub-member 52 and a second sub-member 54. The first sub-member 52 is attached to a top side of the circuit board 20 and the second sub-member 54 is attached to a bottom side of the circuit board 20 to cover the extending portions 40, the welding portions 24, and the conducting terminals 12 thereunder.

As shown in FIG. 3, the covering member 50 has posts 55 received in the openings 42 of the extending portions 40, and the posts 55 have opposite ends connected to the first sub-member 52 and the second sub-member 54 respectively.

In the first preferred embodiment, a die (not shown) is connected to the circuit board 20 to receive the extending portions 40, the welding portions 24, and the conducting terminals 12 in a cavity therein, and then a suitable molding material is provided into the cavity. After the molding material is solidified, the covering member 50 is formed, and portions of the molding material, which are received in the openings 42 of the extending portions 40, form the posts 55.

The posts 55, which are received in the openings 42 of the extending portions 40, may enhance a strength of a connection of the covering member 50 and the circuit board 20 to provide the connection of the cable 10 and the circuit board 20 a strong protection so as to prevent the cable 10 from disconnecting to the circuit board 20 unexpectedly.

In conclusion, the present invention provides a firm structure of a connection of the cable 10 and the circuit board 20 by the covering member 50. It may reduce a risk of the cable 10 disconnecting to the circuit board 20 unexpectedly.

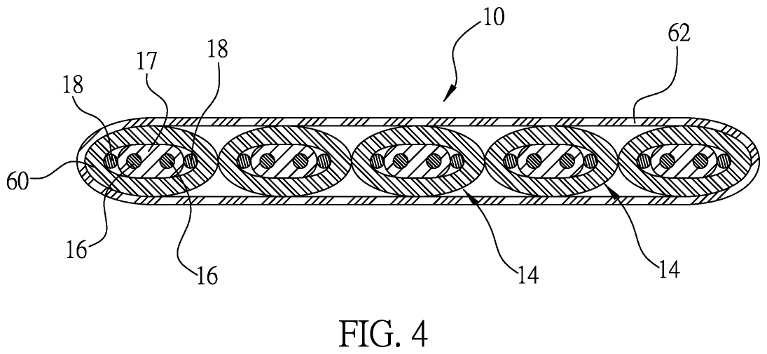

As shown in FIG. 4, the cable 10 includes a plurality of cores 14, and the conducting terminals 12 are connected to ends of the cores 14. Each of the cores 14 includes two conducting wires 16 and two grounding wires 18. The conducting wires 14 are surrounded by an insulating layer 17 for spacing, and the grounding wires 18 are arranged at opposite sides of the insulating layer 17. A conducting layer 60 is provide to surround the grounding wires 18, the insulating layer 17, and the insulating layer 17 therein, and then an outer insulating layer 62 surrounds the conducting layer 60. Ends of the conducting wires 16 are connected to the conducting terminal 12, and ends of the grounding wires are connected to a grounding terminal (not shown). The cable 10 has high resistance to electromagnetic interference to control characteristic impedance and signal's quality.

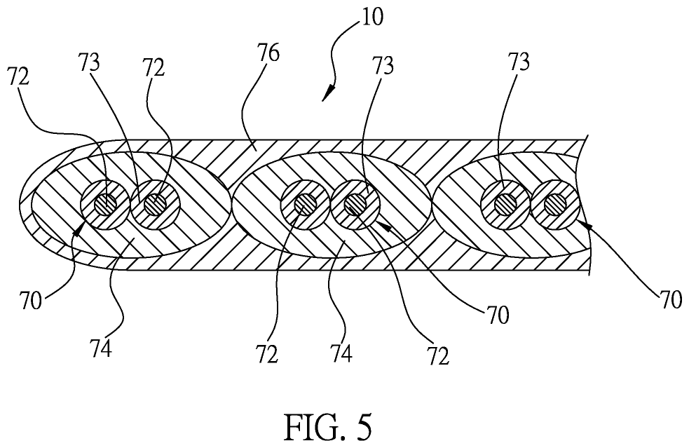

As shown in FIG. 5, the cable 10 includes a plurality of cores 70, each of which includes two conducting wires 72, two insulating layers 73 surrounding the conducting wires 72 respectively, and a conducting layer 74 surrounding the insulating layers 73. The cable 10 further includes an outer insulating layer 76 surrounding the conducting layers 74 of all the cores 70. The conducting layers 74 serve a function of grounding, so that the cable 10 has high resistance to electromagnetic interference to control characteristic impedance and signal's quality. Furthermore, it may increases a density of the wires in a limited space.

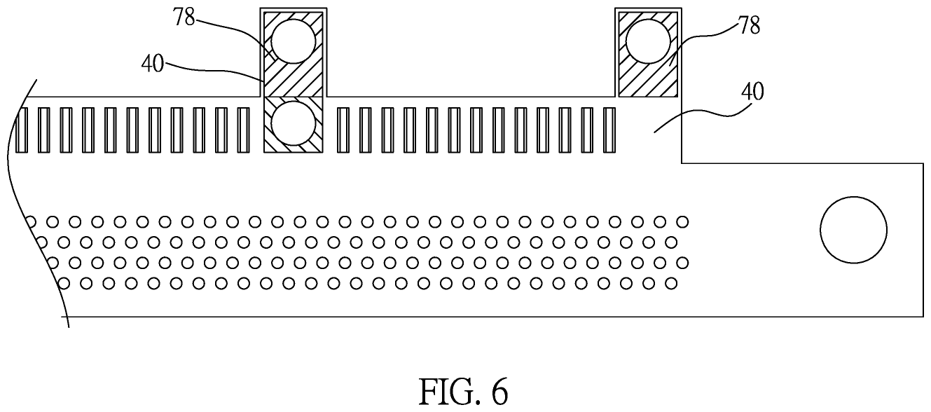

As shown in FIG. 6, the circuit board 20 is provided with grounding layers 78 on the extending portions 40. The grounding layers 78 are electrically connected to the cable 10 for grounding.

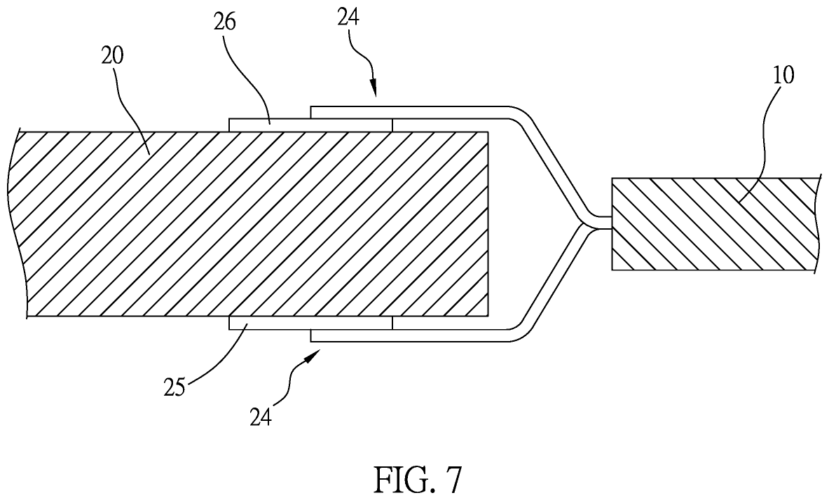

As shown in FIG. 7, the circuit board 20 is provided with two welding portions 24 on the top side and the bottom side. The welding portion 24 on the top side has a plurality of bonding pads 26, and the welding portion 24 on the bottom side has a plurality of bonding pads 25. Some of the conducting wires of the cable 10 go to the top side and connect to the bonding pads 26, and some of the conducting wires go to the bottom side and connect to the bonding pads 25.

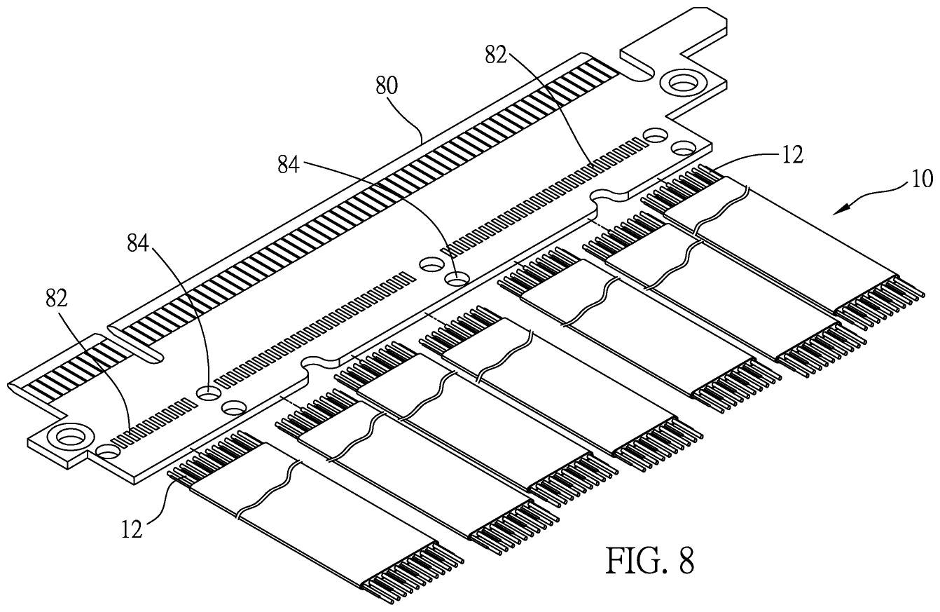

As shown in FIG. 8, a circuit board 80 of the second preferred embodiment of the present invention includes a plurality of bonding pads 82 on a top side and a plurality of openings 84. The cable 10 has the conducting terminals 12 connected to the bonding pads 82 by welding.

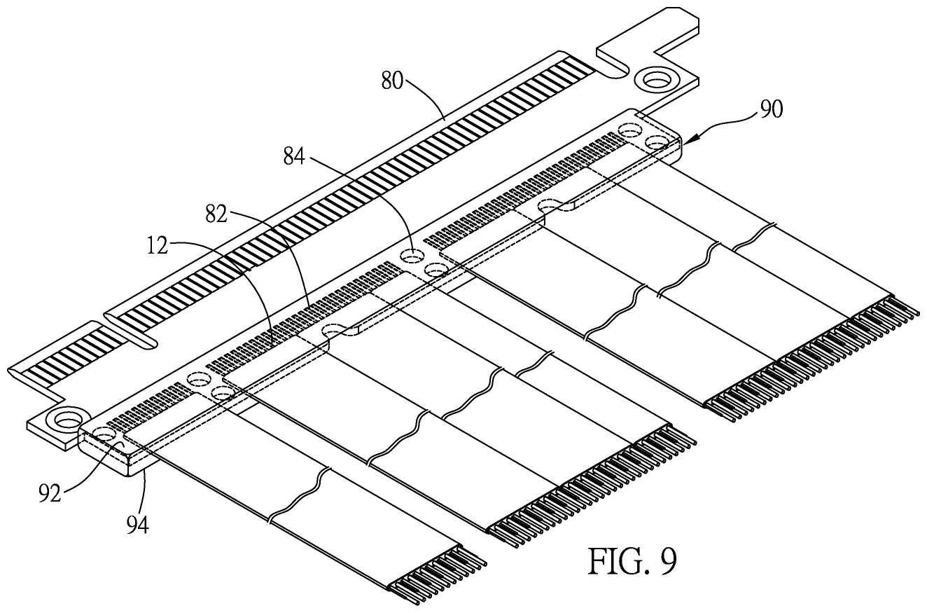

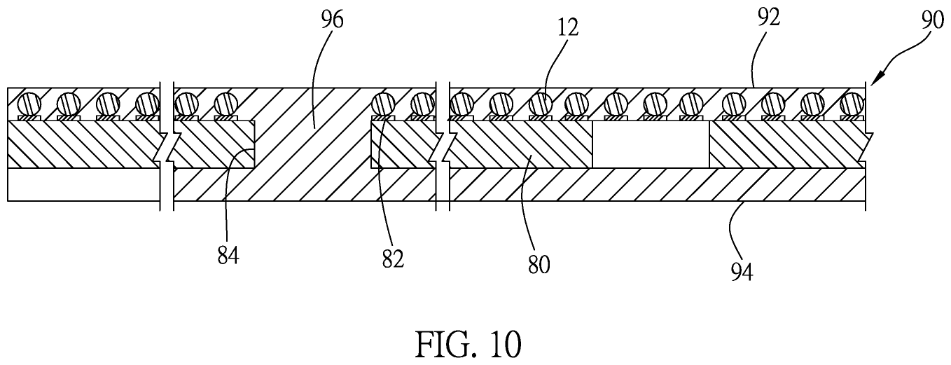

As shown in FIG. 9 and FIG. 10, a covering member 90 has a first sub-member 92 and a second sub-member 94 attached to a top side and a bottom side of the circuit board 80 to cover the bonding pads 82 and the conducting terminals 12 thereunder. The covering member 90 has posts 96 received in the openings 84. The main difference between the first preferred embodiment and the second preferred embodiment is that the circuit board 80 of the second preferred embodiment has no extending portion.

The circuit board 80 of the second preferred embodiment may provide the bonding pads on opposite side to provide the function the same as FIG. 7. The structure of the present invention may be applied to Peripheral Component Interconnect Express Cable (PCIE Cable) and other equivalent devices.

It must be pointed out that the embodiments described above are only some preferred embodiments of the present invention. All equivalent structures which employ the concepts disclosed in this specification and the appended claims should fall within the scope of the present invention.

1. A structure of a connection of a circuit board and a cable, comprising:
a circuit board having a plurality of bonding pads and at least an opening;
a cable having a plurality of conducting terminals, wherein the conducting terminals of the cable are connected to the bonding pads of the circuit board; and a covering member connected to the circuit board to cover the bonding pads of the circuit board and the conducting terminals of the cable, wherein the covering member has at least a post received in the opening of the circuit board;
wherein the post is attached to a sidewall of the opening of the circuit board;
wherein the covering member has portions between each two of the neighboring conducting terminals and touching each of the conducting terminals to separate all the conducting terminals from each other.

2. The structure of claim 1, wherein the circuit board is provided with an extending portion projected from an end thereof, on which the opening is provided.

3. The structure of claim 1, wherein the covering member has a first sub-member and a second sub-member; the first sub-member is attached to a top side of the circuit board while the second sub-member is attached to a bottom side of the circuit board; the post has opposite ends connected to the first sub-member and the second sub-member.

4. The structure of claim 1, wherein the cable has a plurality of cores, each of which has two conducting wires, and the conducting terminals are connected to ends of the conducting wires.

5. The structure of claim 4, wherein each of the cores further includes two grounding wires.

6. The structure of claim 5, wherein each of the cores further includes a conducting layer to warp the conducting wires and the grounding wires therein.

7. The structure of claim 1, wherein the circuit board is provided with a grounding layer to be electrically connected a grounding wire of the cable for grounding.

8. (canceled)

9. The structure of claim 1, wherein the bonding pads are provided on a top side and a bottom side of the circuit board respectively; each two of the neighboring conducting terminals have one of which connected to the bonding pad on the top side and the other one of which connected to the bonding pad on the bottom side to have the cable positioned at the same level as the circuit board.
